(19) United States
(12) Patent Application Publication
(10) Pub. No.: US 2018/0210379 A1
(43) Pub. Date: Jul. 26, 2018

(54) IMAGE FORMING APPARATUS AND IMAGE FORMING METHOD FACILITATING FIXING TONER TO SHEET

(71) Applicants: KABUSHIKI KAISHA TOSHIBA, Tokyo (JP); TOSHIBA TEC KABUSHIKI KAISHA, Tokyo (JP)

(72) Inventors: Kazuhiko Kikuchi, Yokohama Kanagawa (JP); Junichi Nakamura, Mishima Shizuoka (JP); Takaho Watanabe, Mishima Shizuoka (JP)

(21) Appl. No.: 15/459,106

(22) Filed: Mar. 15, 2017

(30) Foreign Application Priority Data
Jan. 25, 2017 (JP) 2017-011503

(51) Int. Cl. G03G 15/20

(52) U.S. Cl. CPC G03G 15/2039

(57) ABSTRACT

According to one embodiment, an image forming apparatus of an embodiment includes a sheet supply unit, a printer unit, a sheet transport unit, a fixing unit, a fixing roller driving unit, and a control unit. The control unit controls the fixing roller driving unit so as to decelerate a second linear velocity to a fourth transport velocity and to switch to a third transport velocity when a first control time elapses after the leading edge of a sheet starts to be transported from a registration position, if the sheet is transported at a first linear velocity before transfer. Alternatively, the control unit controls the fixing roller driving unit so as to decelerate the second linear velocity to the fourth transport velocity and to switch to the third transport velocity when a second control time that is shorter than the first control time elapses, if the sheet is accelerated before transfer.

### CROSS-REFERENCE TO RELATED APPLICATIONS

This application is based upon and claims the benefit of priority from Japanese Patent Application No. 2017-011503, filed Jan. 25, 2017, the entire contents of which are incorporated herein by reference.

### FIELD

Embodiments described herein relate generally to an image forming apparatus.

### BACKGROUND

In the related art, an image forming apparatus includes a fixing device. The fixing device thermally fixes toner to sheet. As the fixing device, for example, a belt fixing device is known.

The belt fixing device includes a fixing roller and a belt. In the belt fixing device, a nip is formed by the contact between the fixing roller and the belt. The belt fixing device can have a nip width wider than that of the nip of the roller fixing device.

However, if the nip width is large, transfer blurring may occur, when the leading edge of a sheet enters the nip, depending on the thickness (basis weight) of the sheet or the like.

### DESCRIPTION OF THE DRAWINGS

FIG. 1 is a schematic cross-sectional view illustrating a configuration example of an image forming apparatus of an embodiment.

FIG. 2 is a schematic cross-sectional view illustrating a part of the image forming apparatus of the embodiment in an enlarged manner.

FIG. 3 is a schematic cross-sectional view illustrating a configuration example of a main part of a fixing device.

FIG. 4 is a block diagram illustrating a configuration example of a control system.

FIG. 5 is a flowchart illustrating an operation example when printing by the image forming apparatus of the embodiment.

FIG. 6 is a schematic graph illustrating an example of a linear velocity of a fixing roller.

FIG. 7 is a schematic graph illustrating an example of a change of a sheet transport velocity.

FIG. 8 is a schematic graph illustrating a relationship between an attenuation rate of a velocity of a fixing roller and image blurring.

### DETAILED DESCRIPTION

An object of an exemplary embodiment is to provide an image forming apparatus capable of suppressing transfer blurring even when various sheets are used.

In general, according to one embodiment, an image forming apparatus includes a sheet supply unit, a printer unit, a sheet transport unit, a fixing unit, a fixing roller driving unit, and a control unit. The sheet supply unit supplies a sheet. The sheet transport unit includes a registration roller. The registration roller adjusts the position of the leading edge of the sheet at the registration position. The printer unit drives an image carrier at a first linear velocity. The printer unit transfers a formed toner image to the sheet at a transfer position. The sheet transport unit transports the sheet from the sheet supply unit toward the transfer position. The fixing unit includes a rotating body and a belt. The rotating body transports the sheet to which the toner image is transferred. The rotating body applies heat to the toner image. A nip is formed between the belt and the rotating body. A sheet is interposed in the nip. The fixing roller driving unit is capable of rotationally driving a rotating body at a third transport velocity at which a second linear velocity of the rotating body is lower than or equal to the first linear velocity or at a fourth transport velocity slower than the third transport velocity. The control unit controls the fixing roller driving unit. If a sheet is transported at a first linear velocity between a registration position and a transfer position, the control unit starts deceleration such that a second linear velocity is a fourth transport velocity when a first control time elapses after the leading edge of the sheet starts to be transported from the registration position. In this case, the control unit controls the fixing roller driving unit so that after the leading edge of the sheet passes through the nip, the second linear velocity switches to the third transport velocity. Alternatively, if a sheet is transported at a first transport velocity faster than a first linear velocity between a registration position and a transfer position and thereafter the sheet is decelerated to a second transport velocity which is equal to the first linear velocity, the control unit starts deceleration such that the second linear velocity is a fourth transport velocity when a second control time which is shorter than the first control time elapses after the leading edge of the sheet starts to be transported from the registration position. In this case, the control unit controls the fixing roller driving unit so that after the leading edge of the sheet passes through the nip, the second linear velocity switches to the third transport velocity.

### Embodiment

Below, an image forming apparatus of an embodiment will be described with reference to the drawings.

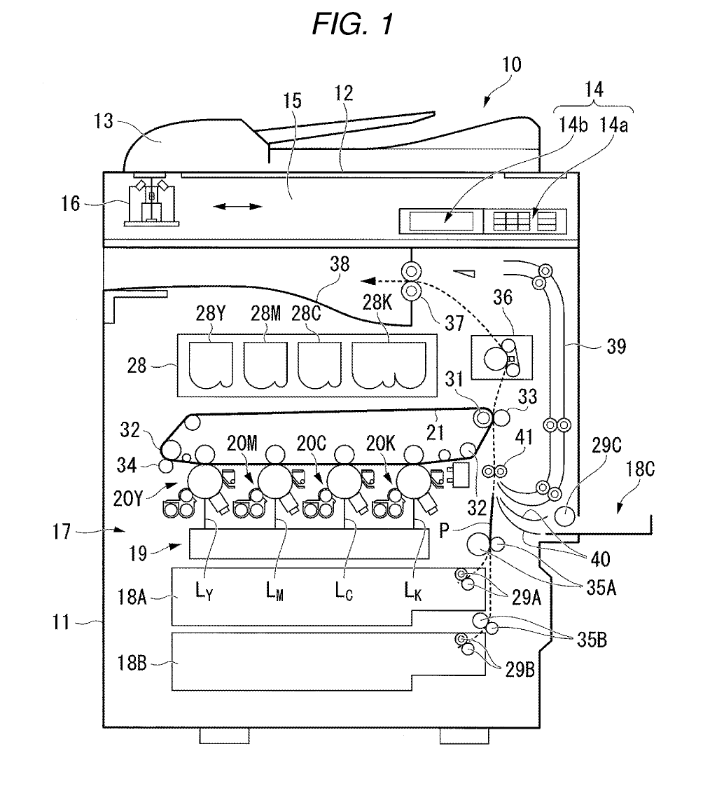

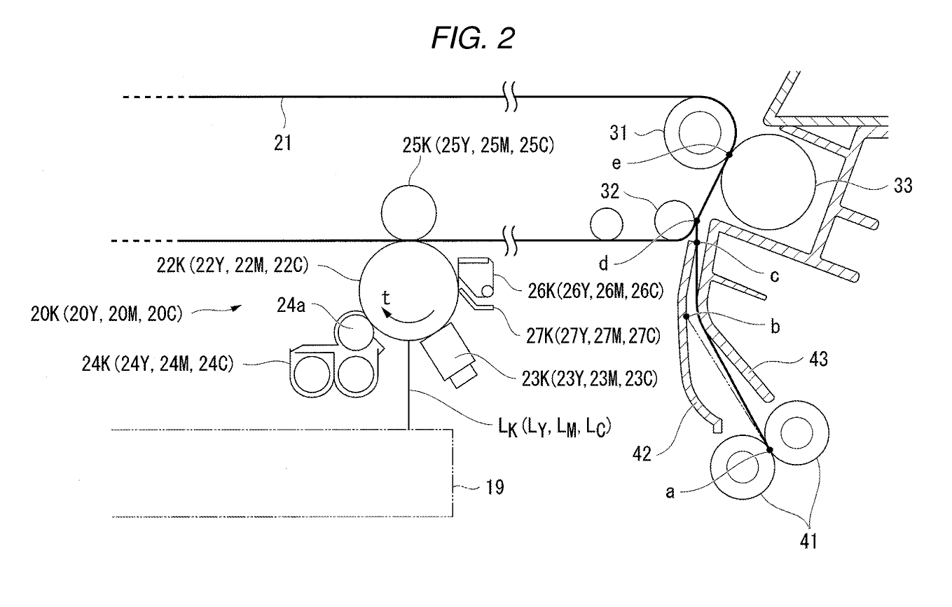

FIG. 1 is a schematic cross-sectional view illustrating a configuration example of an image forming apparatus of an embodiment. FIG. 2 is a schematic cross-sectional view illustrating a part of an image forming unit in the embodiment in an enlarged manner. In FIGS. 1 and 2, dimensions and shapes of respective members are exaggerated or simplified for the sake of clarity (the same applies to the following drawings).

As illustrated in FIG. 1, an image forming apparatus 10 of an embodiment is, for example, a multi-function peripherals (MFP), a printer, a copying machine, or the like.

In the following, an example where the image forming apparatus 10 is an MFP will be described.

A document table 12 including transparent glass is provided on the upper portion of a main body 11 of the image forming apparatus 10. An automatic document feeder (ADF) 13 is provided on the document table 12. An operation unit 14 is provided on the upper part of the main body 11. The operation unit 14 includes an operation panel 14a having various keys and a display unit 14b of a touch panel type.

A scanner unit 15 which is a reading device is provided at the bottom of the ADF 13. The scanner unit 15 reads a document sent by the ADF 13 or an original document placed on the document table 12. The scanner unit 15 generates image data of the original document. For example, the scanner unit 15 includes an image sensor 16. For example, the image sensor 16 may be a contact image sensor.

The image sensor 16 moves along the document table 12, in a case of reading the image of the original document placed on the document table 12. The image sensor 16 reads a document image for one page, one line at a time.

The image sensor 16 reads the original document sent at the fixed position illustrated in FIG. 1 when reading the image of the original document sent by the ADF 13.

The main body 11 of the image forming apparatus 10 includes a printer unit 17 at the center in the height direction.

The main body 11 includes sheet feed cassettes 18A and 18B (sheet supply units) and a manual feed unit 18C (sheet supply unit) at the bottom.

The sheet feed cassettes 18A and 18B are disposed inside the main body 11. The sheet feed cassettes 18A and 18B are disposed to overlap in this order from the upper side.

The manual feed unit 18C protrudes to the side of the main body 11 below a reverse transport path 39 described later.

The sheet feed cassettes 18A and 18B and the manual feed unit 18C accommodate various sizes of sheets P. The sheet feed cassettes 18A and 18B and the manual feed unit 18C accommodate various sizes of sheets P on the center reference. With respect to various sizes of sheets P, the center axis line of the width in the direction orthogonal to the transport direction is aligned with the fixed position.

Examples of the size of the sheet P include postcard size (100 mm×148 mm), CD jacket size (121 mm×121 mm), A5R size (148 mm×210 mm), B5R size (182 mm×257 mm), A4R size (210 mm×297 mm), B5 size (257 mm×182 mm), A4 size (297 mm×210 mm), A3R size (297 mm×420 mm), and the like. Here, the dimensions in the parenthesis represent the length in the transport orthogonal direction x the length in the transport direction.

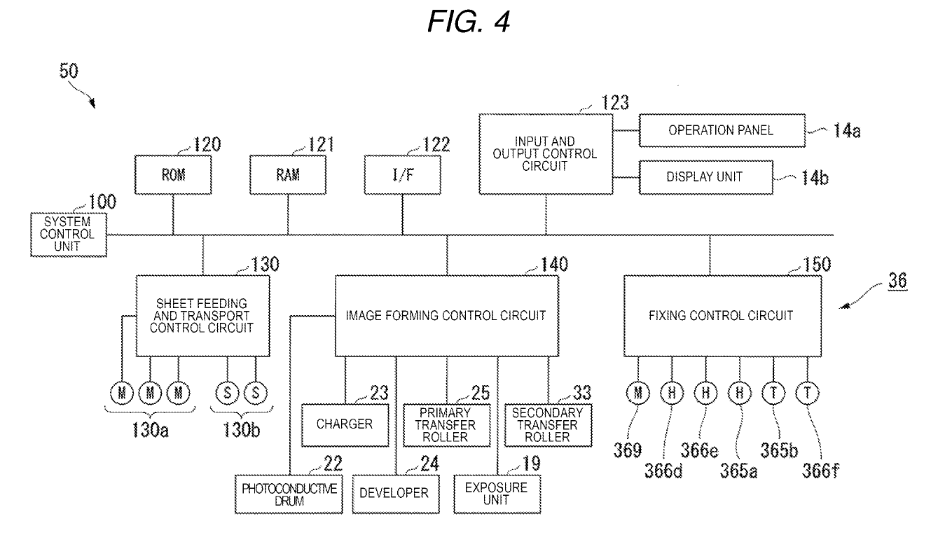

The size of the sheet P accommodated in the sheet feed cassettes 18A and 18B and the manual feed unit 18C is detected by a sheet size detection mechanism (not illustrated). The sheet size detection mechanism notifies a system control unit 100 (see FIG. 4) described later of the size of the sheet P.

The sheet feed cassettes 18A and 18B and the manual feed unit 18C may accommodate sheets P of different types. Examples of the type of the sheet P include types depending on the thicknesses of the sheets P. For example, the sheet P is classified into “plain paper”, “thick paper 1”, “thick paper 2”, and “thick paper 3” according to the basis weight (g/m²) corresponding to the thickness. For example, the basis weight of “plain paper” is 60 g/m² or more and 105 g/m² or less. For example, the basis weight of “thick paper 1” is 106 g/m² or more and 163 g/m² or less. The basis weight of “thick paper 2” is 164 g/m² or more and 209 g/m² or less. The basis weight of “thick paper 3” is 210 g/m² or more and 256 g/m² or less.

The type of the sheet P accommodated in the sheet feed cassettes 18A and 18B and the manual feed unit 18C may be operated and input through the operation panel 14a or the display unit 14b, for example. A system control unit 100 to be described later is notified of the type of the operated and input sheet P.

The sheet feed cassette 18A (18B) includes a sheet feeding mechanism 29A (29B). The sheet feeding mechanism 29A (29B) takes out the sheets P one by one from the sheet feed cassette 18A (18B), and sends them to the transport path. For example, the sheet feeding mechanism 29A (29B) may include a pickup roller, a separation roller, and a sheet feeding roller.

The manual feed unit 18C includes a manual feed mechanism 29C. The manual feed mechanism 29C takes out the sheets P one by one from the manual feed unit 18C and sends them to the transport path.

In the following description, the direction perpendicular to the transport direction of the sheet P along the transport plane of the sheet P in image forming apparatus 10 is referred to as the “transport orthogonal direction”.

The printer unit 17 forms an image on the sheet P based on image data read by the scanner unit 15 or image data generated by a personal computer or the like. The printer unit 17 is, for example, a color printer based on a tandem system.

The printer unit 17 includes image forming units 20Y, 20M, 20C, and 20K of respective colors of yellow (Y), magenta (M), cyan (C), and black (K), an exposure unit 19, an intermediate transfer belt 21 (image carrier).

The image forming units 20Y, 20M, 20C, and 20K are disposed below the intermediate transfer belt 21. The image forming units 20Y, 20M, 20C, and 20K are arranged in parallel from the upstream side to the downstream side in the moving direction on the lower side of the intermediate transfer belt 21 (the direction from the left side to the right side in FIG. 1).

The exposure unit 19 irradiates exposure lights L_{Y}, L_{M}, L_{C}, and L_{K} to the image forming units 20Y, 20M, 20C and 20K, respectively.

The exposure unit 19 may be configured to generate a laser scanning beam as exposure light. The exposure unit 19 may be configured to include a solid state scanning element such as an LED that generates exposure light.

The configurations of the image forming units 20Y, 20M, 20C and 20K are common to each other except for the color of the toner. As the toner, any of normal color toner and decolorable toner may be used. Here, the decolorable toner is a toner which becomes transparent when heated at a certain temperature or higher.

Hereinafter, a configuration common to the image forming units 20Y, 20M, 20C, and 20K will be described with an example of the image forming unit 20K.

As illustrated in FIG. 2, the image forming unit 20K includes a photoconductive drum 22K. The photoconductive drum 22K is an image carrier. A charger 23K, a developer 24K, a primary transfer roller 25K, a cleaner 26K, a blade 27K, or the like are disposed around the photoconductive drum 22K along the rotation direction t.

The charger 23K of the image forming unit 20K uniformly charges the surface of the photoconductive drum 22K.

The exposure unit 19 generates exposure light L_{K} modulated based on the image data. The exposure light L_{K} exposes the surface of the photoconductive drum 22K. The exposure unit 19 forms an electrostatic latent image on the photoconductive drum 22K.

The developer 24K supplies black toner to the photoconductive drum 22K by the developing roller 24a to which the developing bias is applied. The developer 24K develops an electrostatic latent image on the photoconductive drum 22K.

The cleaner 26K includes a blade 27K being in contact with the photoconductive drum 22K. The blade 27K removes residual toner on the surface of photoconductive drum 22K.

The image forming units 20Y, 20M, 20C include photoconductive drums 22Y, 22M, and 22C (image carriers), chargers 23Y, 23M, and 23C, primary transfer rollers 25Y, 25M, and 25C, cleaners 26Y, 26M, and 26C, and blades 27Y, 27M, and 27C which are respectively similar to the photoconductive drum 22K, the charger 23K, the primary transfer roller 25K, the cleaner 26K, and the blade 27K of the image forming unit 20K.

The image forming units 20Y, 20M, and 20C have developer 24Y, 24M, and 24C that correspond to the developer 24K of the image forming unit 20K and in which only toner colors are different.

As illustrated in FIG. 1, a toner cartridge 28 is disposed above the image forming units 20Y, 20M, 20C, and 20K.

The toner cartridge 28 supplies toner to the developers 24Y, 24M, 24C and 24K, respectively. The toner cartridge 28 includes toner cartridges 28Y, 28M, 28C, and 28K. The toner cartridges 28Y, 28M, 28C and 28K contain toner of yellow, magenta, cyan and black, respectively.

Each of the toner cartridges 28Y, 28M, 28C, and 28K is provided with a marker portion for allowing the main body 11 to detect the type of the toner contained therein. The marker portion includes at least toner color information of the toner cartridges 28Y, 28M, 28C and 28K and information for identifying whether the toner is normal toner or decolorable toner.

The intermediate transfer belt 21 moves cyclically. The intermediate transfer belt 21 is stretched over a driving roller 31 and a plurality of driven rollers 32 (see FIG. 1).

As illustrated in FIG. 2, the intermediate transfer belt 21 is in contact with the photoconductive drums 22Y, 22M, 22C, and 22K from the upper side of FIG. 2.

In the intermediate transfer belt 21, a primary transfer roller 25K (25Y, 25M, 25C) is disposed inside the intermediate transfer belt 21 at a position facing the photoconductive drum 22K (22Y, 22M, and 22C).

When the primary transfer voltage is applied, the primary transfer roller 25K (25Y, 25M, and 25C) primarily transfers the toner image on the photoconductive drum 22K (22Y, 22M, 22C) to the intermediate transfer belt 21. The photoconductive drum 22K (22Y, 22M, 22C) constitutes an image carrier which carries a toner image from the developing position to the primary transfer position.

The driving roller 31 faces a secondary transfer roller 33 across the intermediate transfer belt 21. A contact portion between the intermediate transfer belt 21 and the secondary transfer roller 33 forms a secondary transfer position e (transfer position). The driving roller 31 rotationally drives the intermediate transfer belt 21. The rotationally driven intermediate transfer belt 21 constitutes an image carrier carrying a toner image from the primary transfer position to the secondary transfer position e.

A secondary transfer voltage is applied to the secondary transfer roller 33, when the sheet P passes through the secondary transfer position e. When the secondary transfer voltage is applied to the secondary transfer roller 33, the secondary transfer roller 33 secondary transfers the toner image on the intermediate transfer belt 21 to the sheet P.

As illustrated in FIG. 1, a belt cleaner 34 is disposed in the vicinity of the driven roller 32. The belt cleaner 34 removes the residual transfer toner on the intermediate transfer belt 21 from the intermediate transfer belt 21.

As illustrated in FIG. 1, a sheet feeding roller 35A and a registration roller 41 are provided on the transport path from the sheet feed cassette 18A to the secondary transfer roller 33. The sheet feeding roller 35A transports the sheet P taken out from the sheet feed cassette 18A by the sheet feeding mechanism 29A. The registration roller 41 adjusts the position of the leading edge of the sheet P that is fed from the sheet feeding rollers 35A which are in the contact position thereof. The contact position (see point a in FIG. 2) between registration rollers 41 forms a registration position. When the leading edge of the toner image reaches the secondary transfer position, the registration roller 41 transports the sheet P such that the leading edge of the transfer area of the toner image on the sheet P reaches the secondary transfer position. The transfer area of the toner image is a region excluding the formation region of the edge blank portion in the sheet P.

As illustrated in FIG. 2, transport guides 42 and 43 for guiding the transport of the sheet P are disposed between the registration roller 41 and the intermediate transfer belt 21. The transport guide 42 guides the surface of the sheet P to which the toner image is transferred. The transport guide 43 guides the rear surface of the surface of the sheet P to which the toner image is transferred. An inlet opening facing the registration position of the registration roller 41 is formed between the lower ends of the transport guides 42 and 43. An outlet opening through which the sheet P can be inserted is formed between the upper ends of the transport guides 42 and 43. The outlet opening opens at a position facing the intermediate transfer belt 21 stretched by the driving roller 31 and the driven roller 32 below the driving roller 31.

When the leading edge of the toner image reaches the secondary transfer position e, the registration roller 41 transports the sheet P such that the leading edge of the transfer area of the toner image on the sheet P reaches the secondary transfer position e.

As illustrated in FIG. 1, a sheet feeding roller 35B is provided on the transport path from the sheet feed cassette 18B to the sheet feeding roller 35A. The sheet feeding roller 35B transports the sheet P taken out from the sheet feed cassette 18B by the sheet feeding mechanism 29B toward the sheet feeding roller 35A.

A transport path is formed by a transport guide 40 between the manual feed mechanism 29C and the registration roller 41. The manual feed mechanism 29C transports the sheets P taken out from the manual feed unit 18C toward the transport guide 40. The sheet P moving along the transport guide 40 reaches the registration roller 41.

The sheet feeding mechanisms 29A, 29B, the manual feed mechanism 29C, the sheet feeding rollers 35A, 35B, and the registration roller 41, which are described above, constitute a sheet transport unit that transports the sheet P from the sheet supply unit to the transfer position (secondary transfer position e).

A fixing device 36 (fixing unit) is disposed in the downstream of the secondary transfer roller 33 in the transport direction of the sheet P (the upper side in the drawing).

A transport roller 37 is disposed in the downstream of the fixing device 36 in the transport direction of the sheet P (the upper left side in the drawing). The transport roller 37 ejects the sheet P to a paper discharge unit 38.

A reverse transport path 39 is disposed in the downstream of the fixing device 36 in the transport direction of the sheet P (the right side in the drawing). In the reverse transport path 39, the sheet P is inverted and is guided to the secondary transfer roller 33. The reverse transport path 39 is used when duplex printing is performed.

Next, the fixing device 36 will be described in detail.

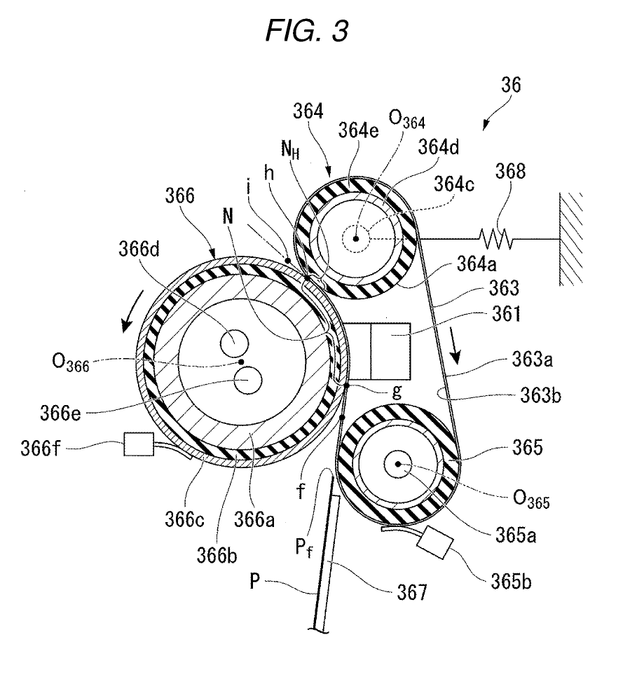

FIG. 3 is a schematic cross-sectional view illustrating a configuration example of a main part of the fixing device of the embodiment.

As illustrated in FIG. 3, the fixing device 36 includes a belt 363, a heat roller 366 (rotating body), a belt heat roller 365, a press roller 364, a pad 361, and thermistors 366f and 365b. The fixing device 36 is surrounded by a case which is not illustrated. An entry opening and a discharge opening are formed in the case. The sheet P can enter the entry opening. The sheet P can be discharged from the discharge opening.

The transport direction of the sheet P entering the fixing device 36 is a direction from the lower side to the upper side in the drawing. The entry opening of the fixing device 36 is provided on the lower side in the drawing. A transport guide 367 is provided below the entry opening of the fixing device 36. The transport guide 367 guides the entry of the sheet P into the entry opening of the fixing device 36.

The discharge opening of the fixing device 36 is provided on the upper side in the drawing.

The belt 363 is an endless belt. The belt width of the belt 363 is wider than the maximum width of the sheet P that can be passed.

The belt 363 is made of a heat resistant material resistant to heating by the heat roller 366 which will be described later. A fluororesin may be laminated on the outer peripheral surface 363a of the belt 363. The inner peripheral surface 363b of the belt 363 is made of a material that reduces the friction with the press roller 364, which will be described later, as compared with the friction between the outer peripheral surface 363a and the sheet P. The surface roughness of the inner peripheral surface 363b of the belt 363 may be 1 or more and 3 or less in an arithmetic average roughness Ra.

For the belt 363, for example, a polyimide base material of which outer peripheral surface is coated with a conductive polytetrafluoroethylene (PFA) tube may be used. For example, the thickness of the polyimide base material may be 60 μm or more and 70 μm or less.

The belt 363 is wrapped around a plurality of rollers on the inner peripheral surface 363b. In the present embodiment, the belt 363 is wrapped around the belt heat roller 365 and the press roller 364 on the inner peripheral surface 363b, which will be described later.

The belt 363 is wrapped around a part of a heat roller 366 which will be described later on the outer peripheral surface 363a.

The heat roller 366 includes a cored bar 366a, an elastic layer 366b, and a release layer 366c. Hereinafter, the heat roller 366 may be called a fixing roller in some cases.

The cored bar 366a is a metal cylindrical member. For example, the cored bar 366a may be made of an aluminum alloy.

Both end portions of the cored bar 366a are supported by a supporting member, not illustrated, of the fixing device 36 through a bearing not illustrated. The cored bar 366a is extended along the center axis O₃₆₆ of the heat roller 366. The center axis O₃₆₆ extends in the illustrated depth direction. The cored bar 366a is rotatable around the center axis O₃₆₆. A gear, not illustrated, is provided in the end portion in the axial direction of the cored bar 366a. The gear transmits rotational driving force to the heat roller 366. The rotational driving force transmitted by the gear is generated by a driving motor 369 (a fixing roller driving unit, see FIG. 4). The rotational driving force generated by the driving motor 369 is transmitted to the gear through transmission mechanism, not illustrated, connected to the driving motor 369.

The type of the driving motor 369 is not particularly limited as long as velocity control is possible. For example, a DC brushless motor, a pulse motor, an ultrasonic motor, or the like may be used as the driving motor 369.

When the rotational driving force is transmitted to the gear, the heat roller 366 rotates counterclockwise about the central axis O₃₆₆.

As illustrated in FIG. 3, the elastic layer 366b is laminated on the outer peripheral surface of the cored bar 366a. The elastic layer 366b is formed in a wider area than the sheet passing area of the sheet P in the transport orthogonal direction.

The elastic layer 366b is formed of, for example, a heat-resistant rubber material. The elastic layer 366b may be formed of, for example, silicone rubber.

As illustrated in FIG. 3, the release layer 366c is laminated on the outer peripheral surface of the elastic layer 366b.

The release layer 366c is formed of a resin material having good releasability to toner. For example, the release layer 366c may be formed of a fluororesin or the like. An example of suitable material for the release layer 366c is PFA.

The outer peripheral surface of the heat roller 366 is formed into an “inverted crown shape” at least in the range of the sheet passing area of the sheet P in the transport orthogonal direction. Here, the “inverted crown shape” is a shape in which the outer diameter is gradually enlarged from the center in the axial direction to both end portions. A difference between the maximum diameter and the minimum diameter of the inverted crown shape in the heat roller 366 (hereinafter, referred to as an “inverted crown amount”) may be 100 μm.

The inverted crown shape of the heat roller 366 may be formed corresponding to the processing shape of the outer peripheral surface of the cored bar 366a. The inverted crown shape of the heat roller 366 may be formed by changing the thickness of at least one of the elastic layer 366b and the release layer 366c.

For example, aluminum alloy pipe material having a thickness 0.9 mm may be used as the cored bar 366a of the heat roller 366. A silicone rubber layer having a thickness of 200 μm may be used as the elastic layer 366b. PFA having a thickness of 50 μm may be used as the release layer 366c. For example, the inverted crown shape may be formed by processing the surface of the cored bar 366a.

As illustrated in FIG. 3, halogen lamps 366d and 366e are inserted in the heat roller 366. Both end portions of the halogen lamps 366d and 366e respectively protrude to the outside of the cored bar 366a. Both end portions of the halogen lamps 366d and 366e are supported by a lamp holder, not illustrated, in the fixing device 36.

The halogen lamps 366d and 366e heat the heat roller 366. The halogen lamps 366d and 366e are configured to be capable of lighting control independently. For example, the fixing device 36 may have a normal fixing mode and a low temperature fixing mode. In the normal fixing mode, both the halogen lamps 366d and 366e may be lit. In the low temperature fixing mode, one of the halogen lamps 366d and 366e may be lit.

The low temperature fixing mode may be used for fixing the image developed with the decolorable toner.

The belt heat roller 365 and the press roller 364 are disposed inside the belt 363. The belt heat roller 365 and the press roller 364 apply tension to the belt 363. The belt heat roller 365 and the press roller 364 are arranged in this order along the transport direction of the sheet P in the fixing device 36.

The belt heat roller 365 is disposed closer to the transport guide 367 than the heat roller 366. The belt heat roller 365 and the heat roller 366 are separated from each other.

The belt heat roller 365 is supported by a supporting member, not illustrated, of the fixing device 36 through a bearing not illustrated. The belt heat roller 365 rotates about the center axis O₃₆₅ extending in the illustrated depth direction.

The belt heat roller 365 may be pressed by a tension spring or the like, not illustrated. The belt heat roller 365 may be pressed by the tension spring to apply tension to the belt 363. However, in the present embodiment, as an example, the position of the center axis O₃₆₅ of the belt heat roller 365 is fixed with respect to the supporting member, not illustrated, of the fixing device 36.

The belt heat roller 365 has a cored bar made of metal. A halogen lamp 365a is inserted in the cored bar of the belt heat roller 365. The halogen lamp 365a heats the cored bar of the belt heat roller 365. The heating temperature by the halogen lamp 365a is set so that the temperature decrease in the nip, which will be described later, is the allowable limit or less.

The surface layer of the belt heat roller 365 may have an elastic layer. In this case, the surface layer of the halogen lamp 365a may be coated with a material having a good releasability. For example, a PFA coat or the like is used for this coating.

The press roller 364 is disposed above the center axis line O₃₆₆ of the heat roller 366 with the belt 363 interposed therebetween. The press roller 364 presses the heat roller 366 with the belt 363 interposed therebetween. A portion of the belt 363 facing the heat roller 366 between the press roller 364 and the belt heat roller 365 is wrapped around the heat roller 366.

The press roller 364 is pressed by a pressing spring 368 from the right side to the left side in the drawing. The pressing spring 368 is fixed to the supporting member, not illustrated, of the fixing device 36. The pressing spring 368 applies tension to the belt 363. Further, the pressing spring 368 presses the press roller 364 against the heat roller 366.

A portion where the heat roller 366 and the belt 363 are in contact when the sheet P is not interposed forms the nip N in the fixing device 36. The length of the nip N in the transport orthogonal direction is longer than the sheet passing area of the sheet P in the transport orthogonal direction. The width (hereinafter, nip width) of the nip N along the peripheral direction of the heat roller 366 is determined according to the amount of heat required for thermal fixing of the toner image transferred to the sheet P. The nip width may be, for example, 12 mm or more and 20 mm or less. Particularly, in the case of fixing the toner image by the decolorable toner, the nip width is more preferably 18 mm or more. Hereinafter, the end portion of the nip N on the upstream side in the transport direction in the nip width direction may be referred to as an inlet portion at the nip N in some cases. The end portion of the nip N on the downstream side in the transport direction in the nip width direction may be referred to as an outlet portion at the nip N in some cases.

In a region where the heat roller 366 and press roller 364 face in the nip N, a high pressure nip portion N_{H} is formed. The high pressure nip portion N_{H} is formed to overlap the outlet portion of the nip N. The sheet P passing through the high pressure nip portion N_{H} receives the applied pressure. The applied pressure in the high pressure nip portion N_{H} is larger than other nips N which are not pressed by the press roller 364.

A pad 361 is disposed in a portion facing the nip N inside the belt 363. The pad 361 is pressed toward the belt 363 by a spring or the like, not illustrated. The pad 361 has a length similar to the length of the nip N. The pad 361 is disposed at a position close to the inlet portion (near the transport guide 367) in the nip width direction at the nip N. The pad 361 stabilizes the nip width of the nip N.

The outer peripheral surface 364a of the press roller 364 is formed into a “regular crown shape” at least in the range of the sheet passing area of the sheet P in the transport orthogonal direction. Here, the “regular crown shape” is a shape in which the outer diameter is gradually decreased from the center in the axial direction to both end portions. A difference between the maximum diameter and the minimum diameter of the regular crown shape in the press roller 364 (hereinafter referred to as a “regular crown amount”) is determined such that the pressure distribution at the contact portion becomes appropriate according to the inverted crown amount of the heat roller 366. For example, in the case of corresponding to the inverted crown amount of 100 μm of the specific dimension example of the heat roller 366 described above, the regular crown amount of the press roller 364 may be 680 μm.

In the present embodiment, the press roller 364 includes a cored bar 364d and an elastic layer 364e.

The cored bar 364d is made of metal. A rotating axis 364c extends at both ends of the cored bar 364d, respectively. The rotating axis 364c is a coaxial with the center axis O₃₆₄. The rotating axis 364c is supported by a supporting member, not illustrated, of the fixing device 36 through a bearing not illustrated. The rotating axis 364c is rotatable around the center axis O₃₆₄.

The elastic layer 363e is laminated on the outer peripheral surface of the cored bar 364d. The elastic layer 363e may be formed of a rubber layer. For example, the elastic layer 363e may be formed of a silicone rubber layer or the like. The rubber hardness (JIS K 6253) of the rubber layer used for the elastic layer 363e may be, for example, A55 or more and A65 or less.

The thickness of the elastic layer 363e may be, for example, 1 mm or more and 3 mm or less.

A low friction coating may be applied to the surface of the elastic layer 364e. For the low friction coating, an appropriate coating having lower friction as compared with the surface of the elastic layer 364e is used. For example, examples of the low friction coating include fluorine coating, silicone coating, and the like.

The regular crown shape of the press roller 364 may be formed corresponding to the processing shape of the outer peripheral surface of the cored bar 364d. The regular crown shape of the press roller 364 may be formed by changing the thickness of the elastic layer 364e.

As illustrated in FIG. 3, the thermistor 366f is in contact with the outer peripheral surface of the heat roller 366. The thermistor 366f detects the temperature of the outer peripheral surface of the heat roller 366. The temperature of the outer peripheral surface of the heat roller 366 detected by the thermistor 366f is used for controlling the temperature of the heat roller 366 in the fixing device 36.

The thermistor 365b is in contact with the outer peripheral surface 363a of the belt 363 wrapped around the belt heat roller 365. The thermistor 365b detects the temperature of the outer peripheral surface 363a of the belt 363. The temperature of the outer peripheral surface 363a of the belt 363 detected by the thermistor 365b is used for controlling the temperature of the belt heat roller 365 in the fixing device 36.

Next, the configuration of the control system of the image forming apparatus 10 will be described.

FIG. 4 is a block diagram illustrating a configuration example of a control system of the image forming apparatus of the embodiment. However, in FIG. 4, for ease of viewing, the members distinguished by the subscripts Y, M, C, and K are collectively represented by symbols from which these subscripts are omitted. For example, the photoconductive drum 22 represents photoconductive drums 22Y, 22M, 22C and 22K. The same is also applied to the charger 23, the developer 24, and the primary transfer roller 25.

In the description with reference to FIG. 4, reference symbols in which subscripts Y, M, C, and K are omitted may be used, based on the illustration in FIG. 4.

As illustrated in FIG. 4, the control system 50 (control unit) includes a system control unit 100, a read only memory (ROM) 120, a random access memory (RAM) 121, an interface (I/F) 122, an input and output control circuit 123, a sheet feeding and transport control circuit 130, an image forming control circuit 140, and a fixing control circuit 150.

The system control unit 100 controls the entire image forming apparatus 10. The system control unit 100 realizes a processing function for image formation by executing programs stored in the ROM 120 or the RAM 121 to be described later.

For the configuration of the system control unit 100, for example, a processor such as a CPU may be used.

The ROM 120 stores a control program, control data and the like for control of the basic operation of the image forming process.

The RAM 121 is a working memory in the control system 50. For example, the control program or control data of the ROM 120 is loaded in the RAM 121 as necessary. Further, the RAM 121 temporarily stores image data sent from the input/output control circuit 123 or data sent from the system control unit 100.

The I/F 122 performs communication with devices connected to the main body 11. For example, the scanner unit 15 is connected to the I/F 122 so as to be communicable. Further, an external device can be connected to the I/F 122. Examples of the external device include a user terminal, a facsimile machine, and the like.

The input/output control circuit 123 controls the operation panel 14a and the display unit 14b. The input/output control circuit 123 sends the operation input received from the operation panel 14a and the display unit 14b to the system control unit 100.

The sheet feeding and transport control circuit 130 controls the driving system included in the main body 11. For example, the drive system includes sheet feeding mechanisms 29A and 29B, sheet feeding rollers 35A and 35B, a manual feed mechanism 29C, a driving motor 130a that drives the registration roller 41. More preferably, a plurality of driving motors 130a are provided.

A plurality of sensors 130b are electrically connected to the sheet feeding and transport control circuit 130. For example, the plurality of sensors 130b include a plurality of sheet detection sensors. A plurality of sheet detection sensors are disposed on the transport path in the main body 11, and inside the sheet feed cassettes 18A, 18B, and the manual feed unit 18C. Each sheet detection sensor detects the presence or absence of the sheet P in the disposed position.

The detection output of each sensor 130b is transmitted from the sheet feeding and transport control circuit 130 to the system control unit 100.

The sheet feeding and transport control circuit 130 controls the driving motor 130a based on the control signal from the system control unit 100 and the detection output from the sensor 130b.

The image forming control circuit 140 controls the photoconductive drum 22, the charger 23, the exposure unit 19, the developer 24, the primary transfer roller 25, and the secondary transfer roller 33, respectively, based on a control signal from the system control unit 100.

The fixing control circuit 150 controls the driving motor 369 and the halogen lamps 366d, 366e, and 365a of the fixing device 36 based on the control signal from the system control unit 100.

The thermistors 365b and 366f are electrically connected to the fixing control circuit 150. The thermistors 365b and 366f respectively send information on the temperatures of the belt 363 and the heat roller 366 to the fixing control circuit 150.

The fixing control circuit 150 performs lighting control of the halogen lamps 366d, 366e, and 365a based on the control signal from the system control unit 100 and the information on temperature from the thermistors 365b and 366f.

The details of the control performed by the control system 50 will be described together with the operation of the image forming apparatus 10.

Next, an image forming method of the present embodiment will be described. The image forming method of the present embodiment is performed by using the image forming apparatus 10. In executing the image forming method of the present embodiment, the image forming apparatus 10 including the fixing device 36 is prepared.

The operation when printing by the image forming apparatus 10 will be described focusing on an image forming method of the present embodiment.

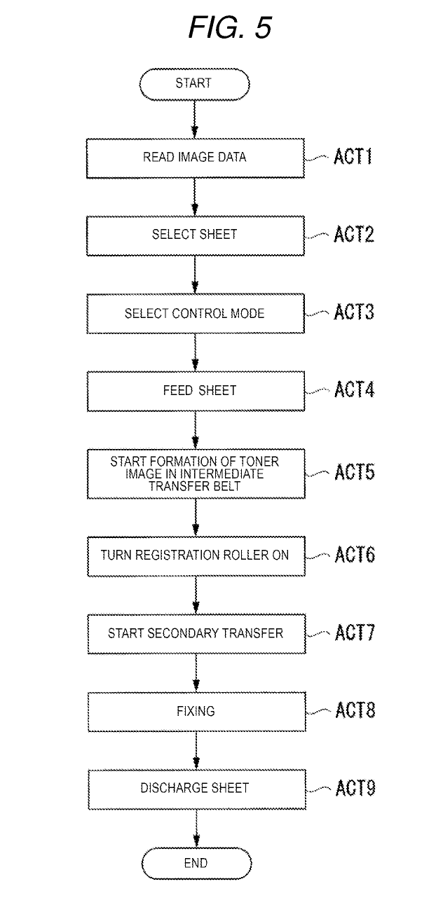

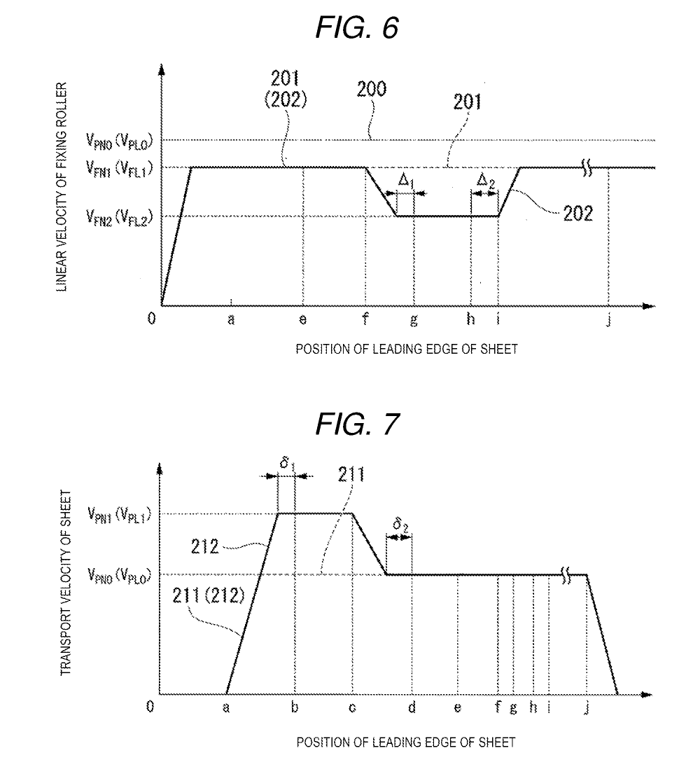

FIG. 5 is a flowchart illustrating an operation example when printing by the image forming apparatus of the embodiment. FIG. 6 is a schematic graph illustrating an example of a linear velocity (second linear velocity) of a fixing roller in the image forming apparatus of the embodiment. The horizontal axis of FIG. 6 represents the position of the leading edge of the sheet P. The vertical axis of FIG. 6 represents the linear velocity of the fixing roller. FIG. 7 is a schematic graph illustrating an example of a change of a sheet transport velocity in the image forming apparatus of the embodiment. The horizontal axis of FIG. 7 represents the position of the leading edge of the sheet. The vertical axis of FIG. 7 represents the transport velocity of the sheet P.

The image forming apparatus 10 prints an image on the sheet P by executing ACT1 to ACT9 illustrated in FIG. 5 according to the flow illustrated in FIG. 5.

In ACT1, the image forming apparatus 10 reads image data.

For example, the reading of image data may be performed by causing the scanner unit 15 to read the original document. In this case, the operator places the original document on the document table 12 or the ADF 13. Thereafter, the operator inputs the scan start operation of the scanner unit 15 through the operation unit 14. The image data read by the scanner unit 15 is stored in the RAM 121 through the I/F 122.

For example, image data may be read from an external device connected to the image forming apparatus 10 through the I/F 122. The image data read from the external device is stored in the RAM 121.

The image data includes print setting information. The print setting information includes at least information on the paper size, the orientation of printing, and the number of sheets to be printed for printing image data. When image data is read from the scanner unit 15, document reading information by the scanner unit 15 or information preset by the operation unit 14 is used as the information on the paper size, the print orientation, and the number of prints.

The print setting information may include, for example, color designation, scaling condition, duplex printing designation, print sheet designation, sheet supply unit designation, and the like. The print sheet designation prescribes the type of the sheet P.

However, the print setting information may be changed by the operator through the operation unit 14. The print setting information changed by the operator is overwritten onto the storage location of the print setting information in the RAM 121.

When the print setting information does not include information necessary for printing, the default print setting stored in the RAM 121 in advance is used.

In the following, a case where image data is read from an external device will be described as an example.

After image data is read, ACT2 is executed. In ACT2, the system control unit 100 selects a sheet P to be used for image formation. The system control unit 100 selects a sheet P based on the print setting information stored in the RAM 121.

This completes ACT2.

Here, for the sake of simplicity, an example in which a sheet P matching the print setting information is accommodated in the sheet supply unit has been described. When there is no sheet P matching the print setting information in the sheet supply unit, the system control unit 100 transmits a warning message to the display unit 14b and an external device. The system control unit 100 prompts resetting of the print setting information.

If ACT2 ends, ACT3 is performed. In ACT3, the system control unit 100 sets a control condition for image formation. The control condition is selected from a plurality of control modes.

For example, the system control unit 100 includes a plain paper fixing mode, a thick paper fixing mode, a decolorable toner fixing mode, and a decolorable toner erasing mode, as control modes related to the fixing temperature.

In the plain paper fixing mode, the thick paper fixing mode, and the decolorable toner fixing mode, appropriate fixing temperatures are set according to the type of sheet P, respectively. Further, when the process linear velocities (first linear velocities) at which toner images are transported during image formation are different, the linear velocity (second linear velocity) of the heat roller 366 is also set corresponding to each process linear velocity. For example, in the thick paper fixing mode and the decolorable toner fixing mode, a process linear velocity different from that of the image formation in the plain paper fixing mode may be used.

In the decolorable toner erasing mode, image formation is not performed. In the decolorable toner erasing mode, passing of used sheets on which image is formed with decolorable toner is performed. The fixing temperature is set to a temperature at which the decolorable toner is made transparent.

If one of the plain paper fixing mode, the thick paper fixing mode, the decolorable toner fixing mode, and the decolorable toner erasing mode is selected, at least the process linear velocity and the fixing temperature are determined.

In addition, the system control unit 100 has control modes such as a fixing roller normal drive mode, a fixing roller deceleration mode, a normal transport mode, and an acceleration transport mode.

The fixing roller normal drive mode and the fixing roller deceleration mode are a control mode related to a rotation velocity of the heat roller 366.

The controls in the fixing roller normal drive mode and the fixing roller deceleration mode are partially different in fixing of a toner image using normal toner (hereinafter, referred to as “normal toner fixing”), fixing of a toner image using decolorable toner (hereinafter, referred to as “decolorizing toner fixing”), fixing to thick paper (hereinafter, referred to as “thick paper fixing”), and decoloring of a used sheet using decolorable toner (hereinafter, referred to as “decoloring”).

In the fixing roller normal drive mode, the control system 50 causes the linear velocity of the heat roller 366 to be the third transport velocity while at least the sheet P passes through the nip N. Specifically, the system control unit 100 sends a control signal to cause the linear velocity of the heat roller 366 to be the third transport velocity, to the fixing control circuit 150. The fixing control circuit 150 controls the rotation of the driving motor 369, based on the control signal from the system control unit 100.

The third transport velocity is, for example, V_{FN1} (normal toner fixing and decoloring) and V_{FL1} (decolorable toner fixation). V_{FN1} [V_{FL1}] is lower than the process linear velocity V_{PN0} [V_{PL0}] in image formation using normal toner (decolorable toner). Here, the process linear velocity is the linear velocities of the photoconductive drum 22 and the intermediate transfer belt 21. For example, V_{FN1} [V_{FL1}] may be 90% or more and 110% or less of V_{PN0} [V_{PL0}].

A polygonal line 201 in FIG. 6 indicates a relationship between the position of the leading edge of the sheet P in the transport and the change of the linear velocity of the heat roller 366. The origin O on the horizontal axis of FIG. 6 indicates the position of the leading edge of the sheet P at the sheet feeding start time (ACT4) of the sheet P described later. Points a and e on the horizontal axis of FIG. 6 correspond to the positions of points a and e in FIG. 2.

Points f, g, h, and i on the horizontal axis of FIG. 6 correspond to the positions of the points f, g, h, and i in FIG. 3. As illustrated in FIG. 3, a point g is in the position of the inlet portion at the nip N. A point h is the position of the outlet portion at the nip N.

The point f is positioned on the designed transport path between the transport guide 367 and the point g. The path length fg is set to a length greater than the transport position variation of the sheet P in the vicinity of the point g.

The point i is positioned on the transport path between the point h and the transport roller 37 (see FIG. 1). The path length hi is greater than 0 mm and is 10 mm or less.

The point j represents the position of the leading edge of sheet P when the trailing edge of the sheet P passes through the transport roller 37.

The lengths of the transport paths on the design from the registration positions at respective points a, e, f, g, h, i, and j in FIG. 3 are Lₐ (=0), Lₑ, L_{f}, L_{g}, Lₕ, Lᵢ, and Lⱼ. L_{g}−Lₕ are the size of the nip width.

However, the relationship between the position of the leading edge of the sheet P and the linear velocity of the heat roller 366 in the polygonal line 201 (the same is applied to the polygonal line 202 to be described later) indicates a correspondence relationship when the sheet P is transported along an ideal transport path. The velocity switching of the heat roller 366 is controlled based on time.

For example, it means that an event of a point x (where x is e, f, g, h, i, and j) in FIG. 6 occurs at the timing of tₓ=t_{T}+(Lₓ−Lₑ)/V_{PN0} [tₓ=t_{T}+(Lₓ−Lₑ)/V_{PL0}], with the time tₐ at which the leading edge of the sheet P is started to be transported from the registration position as the origin. Here, the time t_{T} is a transport time on the design in which the leading edge of the sheet P is transported from the registration position (point a) to the transfer position (secondary transfer position e). As will be described later, the value of the time t_{T} is different in the normal transport mode and the acceleration transport mode.

The actual position of the leading edge of the sheet P at time tₓ may be different from the position on the design. For example, the actual position of the leading edge of the sheet P at time tₓ may deviate from the point x in the fixing device 36, depending on a transport error due to the speed fluctuation of the registration roller 41, the deflection of the sheet P, or the like.

As illustrated by the polygonal line 201 in FIG. 6, the heat roller 366 starts rotation at the same time as the start of sheet feeding of the sheet P, which will be described later, and reaches a linear velocity V_{FN1} [V_{FL1}]. Thereafter, the heat roller 366 is rotated so as to maintain the linear velocity V_{FN1} [V_{FL1}] until the print job based on the print setting is completed.

In the fixing roller normal drive mode, the sheet P passing through the fixing device 36 is transported by the heat roller 366 at the third transport velocity.

In the fixing roller deceleration mode, the control system 50 causes the linear velocity of the heat roller 366 to be a fourth transport velocity while the leading edge of the sheet P is interposed in at least the nip N. The fourth transport velocity is slower than the third transport velocity. For example, the fourth transport velocity may be 96% or more and 97% of the third transport velocity.

In the present embodiment, as an example, the linear velocity of the heat roller 366 changes as the polygonal line 202 in FIG. 6, according to the control signal of the system control unit 100.

As illustrated by a polygonal line 202, from the origin O to the point f, the linear velocity of the heat roller 366 changes in the same way as the polygonal line 201 in the fixing roller normal drive mode.

At the point f, the linear velocity of the heat roller 366 starts to decelerate from the linear velocity V_{FN1} [V_{FL1}]. Specifically, the deceleration of the heat roller 366 is started at the time t_{f}, with the time tₐ as a reference.

The linear velocity of the heat roller 366 is linear velocity V_{FN2} [V_{FL2}] which is the fourth transport velocity, at points between the point f and the point g (including the points f and g). For example, the linear velocity of the heat roller 366 is V_{FN2} [V_{FL2}] at the position on the upstream side by a length Δ₁ (where 0≤Δ₁≤L_{g}−L_{f}) from the point g in the transport direction. Specifically, the linear velocity of the heat roller 366 is V_{FN2} [V_{FL2}] after the elapse of the time t_{g}−Δ₁/V_{PN0} from the time tₐ [after the elapse of the time t_{g}−Δ₁/V_{PL0}].

The linear velocity of the heat roller 366 starts increasing at the point i. The linear velocity of the heat roller 366 returns to the linear velocity V_{FN1} [V_{FL1}] after an acceleration time corresponding to the acceleration performance of the driving motor 369. An acceleration time can be, for example, about 30 msec.

The point i is positioned on the downstream side from the point h by a length Δ₂ in the transport direction. Specifically, the linear velocity of the heat roller 366 starts to increase after the elapse of the time tₕ+Δ₂/V_{PN0} [after the elapse of the time tₕ+Δ₂/V_{PL0}] from the time tₐ. The linear velocity of the heat roller 366 returns to V_{FN1} [V_{FL1}] after the elapse of the time tᵢ from the time tₐ.

The linear velocity of the heat roller 366 is maintained at V_{FN1} [V_{FL1}] from at least the point i to the point j.

Here, Δ₁ and Δ₂ are margins in consideration of transport dispersion of the leading edge of the sheet P. Δ₁ and Δ₂ may be appropriately set as required.

The position of point f is set appropriately so as not to interfere with the transport of the sheet P before entering the nip N.

In this manner, in the fixing roller deceleration mode, the leading edge of the sheet P is transported at the fourth transport velocity by the heat roller 366 while passing through at least the nip N.

The normal transport mode and the acceleration transport mode are a control mode regarding the transport velocity of the sheet P from the registration position to the transfer position.

In the normal transport mode, the control system 50 controls the sheet transport unit such that the sheet P is transported at the process linear velocity between the registration position and the transfer position.

Specifically, the system control unit 100 sends a control signal for causing the linear velocities of the registration roller 41 in the sheet transport unit and the transport unit configured to transport the sheet P to be a process linear velocity, to the sheet feeding and transport control circuit 130. The sheet feeding and transport control circuit 130 controls the rotation of the driving motor 130a, based on the control signal from the system control unit 100.

A polygonal line 211 in FIG. 7 indicates a change in the linear velocity of the registration roller 41. In the sheet transport unit, the linear velocity of the transport unit other than the registration roller 41 is controlled to be substantially the same as (including the same case as) the registration roller 41 so as not to disturb the transport by the registration roller 41. For the sake of simplicity, the operation of the registration roller 41 will be mainly described below.

The meaning of the horizontal axis of FIG. 7 is the same as the horizontal axis of FIG. 6. However, points b, c, and d on the horizontal axis of FIG. 7 correspond to the positions of points b, c, d in FIG. 2, respectively. The lengths of the transport paths on the design from the registration positions at the points b, c, and d are L_{b}, L_{c}, and L_{d}, respectively. This means that an event at a point y (where y is a, b, c, d, and e) in FIG. 7 occurs at a timing of t_{y}=Lₓ/V_{Nave} (y) [t_{y}=L_{y}/V_{Lave}(Y)], with a timing at which the leading edge of the sheet P starts to be transported from the registration position as a time origin. Here, V_{Nave} (y) [V_{Lave} (y)] represents an average linear velocity from the point a to the point y.

As illustrated in FIG. 2, the point b is a position on the design at which the leading edge of the sheet P sent from the registration roller 41 first comes into contact with the transport guide 42. The point d is a position on the design where the sheet P passing through the outlet opening formed by the transport guides 42 and 43 first comes into contact with the intermediate transfer belt 21.

The point c is the position between the point b and the point d on the transport path on the design. The path length cd is set to a length greater than the transport position variation of the sheet P in the vicinity of the point c.

The rotation of the registration roller 41 is stopped while the leading edge of the sheet P is adjusted, after the sheet P is fed as described later. The system control unit 100 sends a control signal to start the rotation of the registration roller 41 to the sheet feeding and transport control circuit 130, after the position of the leading edge of the sheet P is adjusted by the registration roller 41. The timing to start the rotation of the registration roller 41 is the timing at which the leading edge of the transfer area of the toner image on the sheet P reaches the secondary transfer position e when the leading edge of the toner image reaches the secondary transfer position e.

The linear velocity of the registration roller 41 reaches the process linear velocity V_{PN0} [V_{PN0}] before the leading edge of the sheet P reaches the point b. Thereafter, the registration roller 41 is rotated to maintain the linear velocity V_{PN0} [V_{PL0}] until the leading edge of the sheet P reaches the point j. Thereafter, the rotation of the registration roller 41 is stopped.

In the normal transport mode, the sheet P is transported at the process linear velocity by the registration roller 41, except during the rise time of the motor driving the registration roller 41.

Below, the time t_{T} until the leading edge of the sheet P in the normal transport mode reaches the transfer position is expressed as t_{TN1} [t_{TL1}]. t_{TN1} [t_{TL1}] is approximately equal to Lₑ/V_{PN0} [Lₑ/V_{PL0}].

In the acceleration transport mode, the control system 50 controls the sheet transport unit such that the sheet P is transported at a first transport velocity faster than the process linear velocity between the registration position and the transfer position and thereafter, decelerates to a second transport velocity equal to the process linear velocity.

Specifically, the system control unit 100 sends to the sheet feeding and transport control circuit 130, a control signal for causing the linear velocities of the registration roller 41 in the sheet transport unit and the transport unit configured to transport the sheet P to be increased to the first transport velocity and thereafter to be decreased to the second transport velocity. The sheet feeding and transport control circuit 130 controls the rotation of the driving motor 130a, based on the control signal from the system control unit 100.

A polygonal line 212 in FIG. 7 indicates an example of a change in the linear velocity of the registration roller 41. In the sheet transport unit, the linear velocity of the transport unit other than the registration roller 41 is controlled to be substantially the same as (including the same case as) the registration roller 41 so as not to disturb the transport by the registration roller 41. For the sake of simplicity, the operation of the registration roller 41 will be mainly described below.

In the present embodiment, as an example, the linear velocity of the registration roller 41 changes as the polygonal line 212 in FIG. 7, according to the control signal of the system control unit 100.

As indicated by a polygonal line 212, the system control unit 100 sends a control signal to start the rotation of the registration roller 41 to the sheet feeding/transport control circuit 130, similarly to the normal transport mode.

The linear velocity of the registration roller 41 reaches the linear velocity V_{PN1} [V_{PL1}] which is the first transport velocity, before the leading edge of the sheet P reaches the point b. The linear velocity V_{PN1} [V_{PL1}] is faster than the process linear velocity V_{PN0} [V_{PL0}].

In the present embodiment, the linear velocity of the registration roller 41 is V_{PN1} [V_{PL1}] at the position on the upstream side by a length δ₁ (where 0<δ₁<L_{b}−L_{c}) from the point b in the transport direction. δ₁ is a margin in consideration of transport dispersion of the leading edge of the sheet P. δ₁ may be appropriately set as required.

If δ₁ is set, the acceleration is surely completed, before the sheet P comes into contact with the transport guide 42.

Thereafter, the registration roller 41 is rotated to maintain the linear velocity V_{PN1} [V_{PL1}] until the leading edge of the sheet P reaches the point c.

The linear velocity of the registration roller 41 is the process linear velocity V_{PN0} [V_{PL0}] which is the second transport velocity, between the point c and the point d (including the points c and d). For example, the linear velocity of the registration roller 41 is V_{PN0} [V_{PL0}] at the position on the upstream side by a length δ₂ (where 0≤δ₂≤L_{d}−L_{c}) from the point d in the transport direction. δ₂ is a margin in consideration of transport dispersion of the leading edge of the sheet P. δ₂ may be appropriately set as required.

Specifically, the linear velocity of the heat roller 366 returns to V_{PN0} [V_{PL0}] until the time t_{d}=L_{d}/V_{Nave} (d) [t_{d}=L_{d}/V_{Lave}(d)] from the time tₐ.

Thereafter, similar to the normal transport mode, the registration roller 41 is rotated to maintain the linear velocity V_{PN0} [V_{PL0}] until the leading edge of the sheet P reaches the point j. Thereafter, the rotation of the registration roller 41 is stopped.

In the acceleration transport mode, the sheet P is accelerated more than the process linear velocity by the registration roller 41 until the transfer position is reached. The leading edge of the sheet P is transported at an average linear velocity exceeding the process linear velocity by the registration roller 41, between the registration position and the transfer position.

Below, the time t_{T} until the leading edge of the sheet P in the acceleration transport mode reaches the transfer position is expressed as t_{TN2} [t_{TL2}]. t_{TN2} [t_{TL2}] is shorter than t_{TN1} [t_{TL1}].

Here, a description is returned to the operation of the image forming apparatus 10.

As illustrated in FIG. 5, in ACT3, the system control unit 100 selects a control mode based on the print setting information.

The system control unit 100 selects one of the plain paper fixing mode, the thick paper fixing mode, the decolorable toner fixing mode, and the decolorable toner erasing mode. The system control unit 100 sends a control signal to start the warm-up operation of the fixing device 36 to the fixing control circuit 150, based on the selected control mode. The fixing control circuit 150 starts the warm-up operation of the fixing device 36.

The fixing control circuit 150 lights at least one of the halogen lamps 366d and 366e and the halogen lamp 365a. The lighting of the fixing control circuit 150 is controlled such that the heat roller 366 and the belt 363 reach a predetermined fixing temperature. The fixing control circuit 150 monitors the detection outputs of the thermistors 366f and 365b. The fixing control circuit 150 detects the end of the warm-up operation based on the detected output of the thermistors 366f and 365b. Upon completion of the warm-up operation, the fixing control circuit 150 sends a transport permission signal of the sheet P to the system control unit 100.

The system control unit 100 selects either the fixing roller normal drive mode or the fixing roller deceleration mode, based on the information on the type of the sheet P in the print setting information.

For example, the fixing roller deceleration mode may be selected, when the basis weight of the sheet P is 110 g/m² or more. For example, the fixing roller normal drive mode may be selected, when the basis weight of the sheet P is less than 110 g/m². For example, the fixing roller deceleration mode may be selected, in cases other than “plain paper”, according to the classification of “plain paper”, “thick paper 1”, “thick paper 2”, and “thick paper 3” described above. The fixing roller normal drive mode may be selected in the case of “plain paper”.

The system control unit 100 selects either the normal transport mode or the acceleration transport mode, based on the information on the size of the sheet P in the print setting information.

For example, the acceleration transport mode may be used to shorten the inter-sheet distance when transporting the sheets P continuously. In this case, the acceleration transport mode may be selected when the size of the sheet P in the transport direction is large. For example, the acceleration transport mode may be selected when the size of the sheet P in the transport direction exceeds 218 mm. For example, the normal transport mode may be selected when the size of the sheet P in the transport direction is 218 mm or less.

If the control mode is selected, the drive timing and velocity diagram of the driving motor 130a are determined by the sheet feeding and transport control circuit 130. The drive timing and velocity diagram of the driving motor 369 by the fixing control circuit 150 are determined. Specifically, the system control unit 100 may select control data necessary for execution of the control mode from the control data which is stored in the ROM 120 in advance.

Examples 1A, 1B, 2A, 2B, 3A, and 3B of setting the timing of the deceleration start and deceleration end of the fixing roller in the fixing roller deceleration mode are illustrated in Table 1 below.

TABLE 1

| | | Path | Time [msec] | | | | | |
|---|---|---|---|---|---|---|---|---|
| Event | Position | length(mm) | Example 1A | Example 1B | Example 2A | Example 2B | Example 3A | Example 3B |
| Registration | a | 0 | 0 | 0 | 0 | 0 | 0 | 0 |
| roller ON | | | | | | | | |
| Fixing roller | f | 160.5 | 2140 | 1822 | 1070 | 924 | 713.33 | 630.33 |
| deceleration start | | | | | | | | |
| (Nip inlet portion | g | 177.3 | 2364 | 2046 | 1182 | 1036 | 788 | 705 |
| arrival) | | | | | | | | |
| (Nip outlet | h | 197 | 2626.7 | 2308.7 | 1313.33 | 1167.33 | 875.56 | 792.56 |
| portion arrival) | | | | | | | | |
| Fixing roller | i | 207 | 2626.83 | 2308.83 | 1380 | 1234 | 920 | 837 |
| deceleration end | | | | | | | | |

As illustrated in Table 1, the transport paths of Examples 1A, 1B, 2A, 2B, 3A, and 3B are common. With the point a as a reference, the path lengths L_{f}, L_{g}, and Lᵢ of the points f, g, h, and i are 160.5 mm, 177.3 mm, 197 mm, and 207 mm. The nip width is 19.7 mm (=Lₕ−L_{g}).

The point a is a registration position. The event at the point a is the start of rotation of the registration roller 41 (“registration roller ON”). The event at the point f is the deceleration start of the heat roller 366. The events at the points g and h are arrival at the inlet portion and the outlet portion of the nip N of the leading edge of the sheet P, respectively. The event at the point i is the deceleration end of the heat roller 366. Among them, the events controlled by the control system 50 are events at points a, f, and i.

The process linear velocity of Examples 1A and 1B are set to 75 mm/s. The process linear velocities of Examples 1A and 1B are suitable for the case where, for example, the sheet P is thick paper. The process linear velocities of Examples 2A and 2B are set to 150 mm/s. The process linear velocities of Examples 2A and 2B are suitable for a medium-speed machine having, for example, a print velocity of about 30 sheets/minute. The process linear velocities of Examples 3A and 3B are set to 225 mm/s. The process linear velocities of Examples 3A and 3B are suitable for a high-speed machine having, for example, a print velocity of about 50 sheets/minute.

In Examples 1A, 2A, and 3A, the normal transport mode (a speed increasing rate 0%) is selected. In Examples 1B, 2B and 3B, the acceleration transport mode is selected.

In addition, when selection of all control modes necessary for image formation is completed, ACT3 is ended.

As illustrated in FIG. 5, when ACT3 ends, ACT4 is performed. In ACT4, the sheet feeding of the sheet P selected in ACT2 is performed. Specifically, the system control unit 100 sends a control signal to start the sheet feeding of the sheet P, to the sheet feeding and transport control circuit 130. The sheet feeding and transport control circuit 130 performs control for feeding the sheet P from the sheet supply unit that accommodates the selected sheet P, based on a control signal from the system control unit 100. For example, in a case of the sheet P accommodated in the sheet feed cassette 18A, the sheet feeding mechanism 29A is driven. Further, the sheet feeding and transport control circuit 130 drives the sheet transport unit in the transport path up to the registration roller 41. For example, in a case of the sheet P accommodated in the sheet feed cassette 18A, the sheet feeding roller 35A is driven.

The sheet transport unit stops in a state where the leading edge of the sheet P comes into contact with the registration roller 41.

This completes ACT4.

After ACT4, ACT5 is performed. In ACT5, formation of a toner image on the intermediate transfer belt 21 is started. Specifically, the system control unit 100 determines whether a transport permission signal is received from the fixing control circuit 150. If a transport permission signal has been received, the system control unit 100 sends a control signal to start forming of a toner image, to the sheet feeding and transport control circuit 130, the image forming control circuit 140, and the fixing control circuit 150.

The sheet feeding and transport control circuit 130, the image forming control circuit 140, and the fixing control circuit 150 start the control operation in parallel, respectively.

This completes ACT5.

The image forming control circuit 140 starts the image forming processes of the image forming units 20Y, 20M, 20C, and 20K in this order. In the respective image forming units 20Y, 20M, 20C, and 20K, electrostatic latent images are written onto the surfaces of the photoconductive drums 22Y, 22M, 22C, and 22K by the exposure light L_{Y}, L_{M}, L_{C}, and L_{K} from the exposure unit 19. The respective electrostatic latent images are developed by the developers 24Y, 24M, 24C, and 24K.

The developed toner images are primarily transferred to the intermediate transfer belt 21 by the primary transfer rollers 25Y, 25M, 25C, and 25K. Respective toner image forming areas are overlapped by respective primary transfers. The respective toner images stacked on the intermediate transfer belt 21 are transported toward the secondary transfer position e by the intermediate transfer belt 21.

In parallel with such an operation of the image forming control circuit 140, ACT6 is performed. At ACT6, the driving motor 130a for driving the registration roller 41 is driven by the sheet feeding and transport control circuit 130 at a timing when the toner image reaches a predetermined position. The driving motor 130a starts the rotation of the registration roller 41.

The linear velocity of the registration roller 41 is controlled according to the velocity diagram corresponding to the selected control mode by the sheet feeding and transport control circuit 130.

This completes ACT6.

Assuming that the leading edge of the toner image reaches the secondary transfer position e at time t₀, a time tᵣ for driving the registration roller 41 to start is t₀−(t_{T}+Δt). Here, the time t_{T} is the transport time on the design at which the leading edge of the sheet P described above is transported from the registration position to the secondary transfer position e. Δt (where Δt>0) is a time for forming a blank portion of the leading edge portion of the sheet P. Δt is set to such a size that a blank portion can be reliably formed even considering the process linear velocity and the transport error between the intermediate transfer belt 21 and the sheet P. Δt is constant according to the combination of the selected control modes. t₀−tᵣ (=t_{T}+Δt) is shorter in the accelerated transport mode than in the normal transport mode. In the acceleration transport mode, it is possible to form the toner image on the intermediate transfer belt 21 at a faster timing than in the normal transport mode. Particularly, when the sheets P of the same size are continuously printed, the transport interval of sheets P is shortened. In the acceleration transport mode, substantial print velocity of the image forming apparatus 10 can be improved.

As illustrated in FIG. 5, when ACT6 ends and the leading edge of the sheet P reaches the secondary transfer position e, ACT7 is performed. Regardless of a selected control mode, by the time when the leading edge of the sheet P reaches the secondary transfer position e, the linear velocity of the registration roller 41 is the process linear velocity.

In ACT7, the toner image on the intermediate transfer belt 21 is secondarily transferred to the sheet P. Specifically, the image forming control circuit 140 applies a secondary transfer voltage to the secondary transfer roller 33 during the time tᵣ+t_{T} (=t₀−Δt) at which the leading edge of the sheet P reaches the secondary transfer position e. The toner image is secondarily transferred to the sheet P passing through the secondary transfer position e. The secondary transfer roller 33 rotates in the opposite direction to the intermediate transfer belt 21 at the same linear velocity. The sheet P is transported in the transport direction at the process linear velocity while secondary transfer is performed. The sheet P that has passed through the secondary transfer position e is transported along the transport path toward the fixing device 36.

The image forming control circuit 140 stops applying the secondary transfer voltage, after the trailing edge of the sheet P passes through the secondary transfer position e.

When the sheet P that has passed through the secondary transfer position e enters the fixing device 36, ACT8 is performed. In ACT8, the toner image is fixed on the sheet P by the fixing device 36.

As illustrated in FIG. 3, the sheet P enters between the belt 363 and the heat roller 366 along the transport guide 367. The nip N is heated to the fixing temperature according to the control mode.

The fixing control circuit 150 controls the rotation velocity of the driving motor 369 according to the selected control mode. For example, in the fixing roller normal drive mode, the rotation velocity of the driving motor 369 is controlled such that the linear velocity of the heat roller 366 varies according to the polygonal line 201 in FIG. 6. For example, in the fixing roller deceleration driving mode, the rotation velocity of the driving motor 369 is controlled such that the linear velocity of the heat roller 366 varies according to the polygonal line 202 in FIG. 6.

In particular, in the fixing roller deceleration driving mode, the fixing control circuit 150 starts deceleration to reduce the linear velocity of the heat roller 366 from the third transport velocity to the fourth transport velocity, according to the time on the design when the leading edge P_{f} of the sheet P reaches the point f. The point f is on the upstream side in the transport direction from the point g. L_{g}−L_{f} has a margin with respect to the transport error of sheet P. As illustrated in FIG. 6, the linear velocity of the heat roller 366 is the fourth transport velocity until the inlet portion (point g) of the nip N is reached.

The deceleration start timing is a time when the time t_{f}−tₐ has elapsed since the leading edge P_{f} of the sheet P starts to be transported from the registration position.

For example, the time t_{f}−tₐ is the first control time t_{TN1}+(L_{f}−Lₑ)/V_{PN0} when the normal transport mode is selected, assuming that the process linear velocity is V_{PN0}. The time t_{f}−tₐ is the second control time t_{TN2}+(L_{f}−Lₑ)/V_{PN0} when the acceleration transport mode is selected. Here, t_{TN1}>t_{TN2}.

As described above, in the normal transport mode and the acceleration transport mode, the heat roller 366 is decelerated to the fourth transport velocity, at a constant region (between the point f and the point g) on the upstream side in the transport direction from the inlet portion of the nip N, by changing the time t_{f}−tₐ.

The above is applied to the case where the process linear velocity is V_{PL0}.

When the leading edge P_{f} of the sheet P enters the nip N in a state where the linear velocity of the heat roller 366 is decelerated to the fourth transport velocity, the external force acting on the sheet P from the heat roller 366 at the time of entering is reduced. Further, a larger slack of the sheet P is formed between the secondary transfer positions e and the nip N, compared to the case where the heat roller 366 is not decelerated. The formed slack suppresses the transmission of the external force acting on the leading edge portion of the sheet P to the trailing edge side.

In the fixing roller deceleration mode, the influence of the external force received by the sheet P when entering the nip N is less likely to reach the secondary transfer position e. As a result, image blurring during secondary transfer is suppressed.

When the sheet P enters the nip N, the sheet P is heated at the fixing temperature. The fixing temperature is controlled to be constant by the fixing control circuit 150. Further, the sheet P is pressed between the heat roller 366 and the belt 363. The toner image adhered to the sheet P is thermally fixed on the sheet P.

The fixing control circuit 150 continues to control the driving motor 369 according to the selected velocity diagram. For example, in the fixing roller deceleration mode, the linear velocity of the heat roller 366 starts to increase when the leading edge P_{f} of the sheet P reaches the point i on the downstream side in the transport direction rather than the nip N. Further, the linear velocity of the heat roller 366 is returned to the fourth transport velocity equal to the process linear velocity after a predetermined acceleration time.

The sheet P is discharged out of the fixing device 36 toward the transport roller 37 at the process linear velocity, after the time on the design when at least the leading edge P_{f} passes through the point i.

This completes ACT8.

As illustrated in FIG. 5, after ACT8, ACT9 is performed.

In ACT9, the sheet P is discharged. The sheet P discharged from the fixing device 36 reaches the transport roller 37. The transport roller 37 discharges the sheet P to the paper discharge unit 38.

This completes the image formation on one sheet P.

In the case of forming images on a plurality of sheets P in the print job, under the control of the system control unit 100, after the trailing edge of the preceding sheet P has passed the registration roller 41, the above-mentioned ACT3 on the following sheet P is executed. In the following, ACTs 4 to 9 described above are repeated for the following sheet P in the same manner.

In the image formation of the following sheet P, the toner image is formed in the intermediate transfer belt 21 at a timing when a certain sheet interval is spaced from the trailing edge of the preceding sheet P.

However, when the acceleration transport mode is selected, the sheet interval is shortened compared to the normal transport mode.

The system control unit 100 stops the sheet transport unit in the image forming apparatus 10, when image formation is performed on the following sheet P for the number of sheets specified in the print setting. This completes the print job.

According to the image forming apparatus 10 of the present embodiment, the fixing roller normal driving mode, the fixing roller deceleration mode, the normal transport mode, and the acceleration transport mode are appropriately combined according to various sheets P to form an image. For example, the substantial print velocity is improved by choosing the acceleration transport mode for the sheet P with a large size. For example, the image blurring during secondary transfer is suppressed by selecting the fixing roller deceleration mode for the sheet P with a large basis weight.

When the fixing roller deceleration mode is selected, a time to start transporting the sheet P from the registration position is automatically switched between the first control time and the second control time in the normal transport mode and the acceleration transport mode. Therefore, regardless of the presence or absence of acceleration of the registration roller 41, image blurring is reliably suppressed.

Here, a change in transfer blurring caused by deceleration of the heat roller 366 will be described based on experimental results.

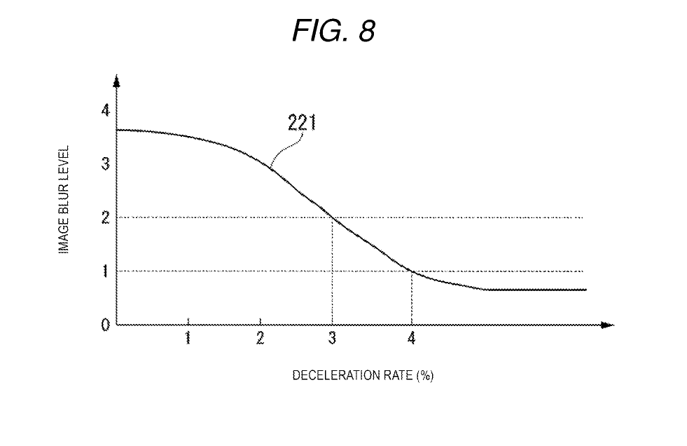

FIG. 8 is a schematic graph illustrating a relationship between a deceleration rate of a fixing roller and image blurring. For ease of view, FIG. 8 depicts a curve 221 which approximates the measured value by a curve.

The horizontal axis of FIG. 8 represents the deceleration rate (%) of the fixing roller. The deceleration rate (%) is defined as (v₂−v₁)×100/v₁. Here, v₁ is the third transport velocity, and v₂ is the fourth transport velocity.

The vertical axis of FIG. 8 indicates an image blur level. The image blur level is determined by visually comparing image samples with step samples. As step samples of the image blur level, samples of five levels of Levels 0, 1, 2, 3, and 4 are prepared in the order of worse image blurring. An image of Level 2 or lower is an image in an acceptable range.

A3 and 250 g paper is used as the size and type of sheet P.

As indicated by the curve 221, the image blur level is the worst at the deceleration rate of 0%. The image blur level approaches 0 as the deceleration rate increases. In particular, when the deceleration rate is 3% or more, the image blur level is Level 2 or less. Further, at a deceleration rate of 4% or more, the image blur level is Level 1 or less which is extremely good. At a deceleration rate of 4% or more, the change of the image blur level is almost flat.

If the deceleration rate is too large, for example, slack may be large on the sheet P. If the slack is too large, friction may occur on the un-transferred image. If the slack is too large, it may be difficult to pass thick paper.

The deceleration rate is more preferably 3% or more and 4% or less.

In the above description of the embodiment, an example is described in which the heat roller 366 and the belt heat roller 365 are heated by halogen lamps 366d, 366e, and 365a, respectively. However, heating unit of the heat roller 366 and the belt heat roller 365 is not limited to the halogen lamp. For example, the heat roller 366 and the belt heat roller 365 may be heated by a resistance heating heater, an IH heater, or the like.

In the above description of the embodiment, an example is described in which the belt 363 is stretched by two rollers of the press roller 364 and the belt heat roller 365. However, the belt 363 may be stretched by three or more rollers.

In the above-described embodiment, even if either the normal transport mode or the acceleration transport mode is selected in the fixing roller deceleration driving mode, a case is described in which deceleration is started at a point f which is a constant position before the nip N is reached. However, time to start the deceleration of the heat roller 366 may be time corresponding to the position where the path length from the inlet portion of the nip N is different, when the normal transport mode is selected and a case where the acceleration transport mode is selected.

According to at least one embodiment described above, it is possible to provide an image forming apparatus capable of suppressing transfer blurring even when various sheets are used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a sheet supply unit that supplies a sheet;
a printer unit that drives an image carrier at a first linear velocity, and transfers a formed toner image to the sheet at a transfer position;
a sheet transport unit that includes a registration roller which adjusts the position of the leading edge of the sheet at the registration position and transports the sheet from the sheet supply unit to the transfer position;
a fixing unit including a rotating body that transports the sheet to which the toner image is transferred and applies heat to the toner image, and a belt for forming a nip sandwiching the sheet between the rotating body and the belt;
a fixing roller driving unit that is capable of rotating and driving the rotating body at a third transport velocity at which a second linear velocity of the rotating body is the first linear velocity or lessor at a fourth transport velocity slower than the third transport velocity; and
a control unit that
controls the fixing roller driving unit so as to start deceleration such that the second linear velocity is the fourth transport velocity when a first control time elapses after the leading edge of the sheet starts to be transported from the registration position, and to switch the second linear velocity to the third transport velocity after the leading edge of the sheet passes through the nip, if the sheet is transported at the first linear velocity between the registration position and the transfer position, or
controls the fixing roller driving unit so as to start deceleration such that the second linear velocity is the fourth transport velocity when a second control time shorter than the first control time elapses after the leading edge of the sheet starts to be transported from the registration position, and to switch the second linear velocity to the third transport velocity after the leading edge of the sheet passes through the nip, if the sheet is transported at a first transport velocity faster than the first linear velocity and thereafter the sheet is decelerated to a second transport velocity which is equal to the first linear velocity between the registration position and the transfer position.

2. The apparatus according to claim 1,
wherein the control unit controls the fixing roller driving unit so as to be the fourth transport velocity while at least the leading edge of the sheet is interposed in the nip.

3. The apparatus according to claim 1,
wherein the control unit switches depending on a size and a type of the sheet, between controlling the sheet transport unit such that the sheet is transported at the first linear velocity between the registration position and the transfer position, and controlling the sheet transport unit such that the sheet is decelerated to the second transport velocity after the sheet is transported at the first transport velocity between the registration position and the transfer position.

4. The apparatus according to claim 1,
wherein a length that the sheet is transported within the first control time by the registration roller is equal to a length that the sheet is transported within the second control time by the registration roller.

5. The apparatus according to claim 1,
wherein the control unit controls the fixing roller driving unit so as to start deceleration such that the second linear velocity is the fourth transport velocity, and in a case of controlling the fixing roller driving unit so as to switch the second linear velocity to the third transport velocity after the leading edge of the sheet passes through the nip, the control unit controls the fixing roller driving unit such that the second linear velocity is the fourth transport velocity before the leading edge of the sheet reaches the nip.

6. An image forming method comprising:
providing a fixing unit including a rotating body that applies heat to a toner image and a belt that forms a nip between the rotating body and the belt;
driving an image carrier at a first linear velocity to form a toner image;
feeding a sheet to a registration position and transporting the sheet to a transfer position;
transferring the toner image to the sheet at the transfer position; and
fixing the toner image on the sheet,
by driving the rotating body so as to start deceleration such that a second linear velocity of the rotating body is a fourth transport velocity which is slower than a third transport velocity at which a second linear velocity of the rotating body is the first linear velocity or less when a first control time elapses after the leading edge of the sheet starts to be transported from the registration position, and to switch the second linear velocity to the third transport velocity after the leading edge of the sheet passes through the nip, if the sheet is transported at the first linear velocity between the registration position and the transfer position, or
by driving the rotating body so as to start deceleration such that the second linear velocity is the fourth transport velocity when a second control time which is shorter than the first control time elapses after the leading edge of the sheet starts to be transported from the registration position, and to switch the second linear velocity to the third transport velocity after the leading edge of the sheet passes through the nip, if the sheet is transported at a first transport velocity faster than the first linear velocity and thereafter the sheet is decelerated to a second transport velocity which is equal to the first linear velocity between the registration position and the transfer position.

7. The method according to claim 6,
wherein the second linear velocity is switched to be the fourth transport velocity at least while the leading edge of the sheet is interposed in the nip.

8. The method according to claim 6,
wherein switching between transporting the sheet at the first linear velocity and transporting the sheet at the first transport velocity and thereafter performing deceleration to the second transport velocity, between the registration position and the transfer position, is performed according to a size and a type of the sheet.

9. The method according to claim 6,
wherein a length that the sheet is transported from the registration position within the first control time is equal to a length that the sheet is transported from the registration position within the second control time.

10. The method according to claim 6,
wherein if the second linear velocity is decelerated to the fourth transport velocity, the second linear velocity is decelerated to the fourth transport velocity, before the leading edge of the sheet reaches the nip.
